(19) United States
(12) Patent Application Publication
(10) Pub. No.: US 2011/0310626 A1
(43) Pub. Date: Dec. 22, 2011

(54) LIGHTING DEVICE

(76) Inventors: Wakaaki Itohara, Osaka (JP); Yutaka Takashige, Osaka (JP)

(21) Appl. No.: 13/202,262

(22) PCT Filed: Nov. 13, 2009
(86) PCT No.: PCT/JP2009/006064

§ 371 Date: Aug. 18, 2011

(30) Foreign Application Priority Data
Feb. 19, 2009 (JP) 2009-036643
Feb. 19, 2009 (JP) 2009-036644

(51) Int. Cl. F21V 21/00

(52) U.S. Cl. 362/382

(57) ABSTRACT

Two partition plates are opposite to each other on a rectangular body frame along the longitudinal direction of the body frame. A power-supply unit, a connection terminal, grips, etc., are juxtaposed with LED modules in a compartment defined between the partition plates. Further, the LED modules are mounted in the compartments defined between each of the partition plates and each of the longitudinal edges of the body frame. Namely, two groups of the LED modules are juxtaposed on the body frame so that the power-supply unit, the connection terminal, and the like are provided between the two groups of the LED modules.

This application is the national phase under 35 U.S.C. §371 of PCT International Application No. PCT/JP2009/006064 which has an International filing date of Nov. 13, 2009 and designated the United States of America.

### BACKGROUND

1. Technical Field

The present invention relates to a lighting device which can be easily attached.

2. Description of Related Art

In recent years, lighting devices have been developed that use, as the light source, light emitting diodes or the like instead of a fluorescent lamp or an incandescent lamp since they are excellent in power saving and longevity. Such lighting devices have a structure in which a substrate (LED module) mounted with a plurality of light emitting diodes (LEDs), a driving circuit (power-supply circuit) that drives the LEDs, and the like are attached within a lighting fixture.

Such lighting devices using LEDs adopt a two-tier structure in which the substrate is disposed with the LEDs downside so that the light emitting surface is downside when the lighting device is installed on a ceiling and parts including the driving circuit and the power-supply circuit, a circuit board and the like are disposed on the back side (upside) of the LED module so that the light emitting surface is not blocked. For example, Japanese Patent Application Laid-Open No. 2005-71711 discloses a lighting device having a structure in which the body mounted with electronic parts is fixed to a ceiling surface and then, the LED unit is attached to the body.

### SUMMARY

However, in the case of the conventional lighting device as disclosed in Japanese Patent Application Laid-Open No. 2005-71711, the LED module (substrate mounted with LEDs) and the power-supply unit such as the driving circuit that drives the LEDs are formed into a two-tier structure. To install such a lighting device onto a ceiling, work is necessary of, first, attaching a lighting fixture housing accommodating the power-supply unit to the ceiling and then, attaching the LED module to the lighting fixture housing. For this reason, the work of installing a lighting device takes much time. In particular, since the work of installing a lighting device onto a ceiling surface which work includes work in high places is a burden on the workers, improved work efficiency leads to improved work safety, and it is demanded that the work process be simplified.

The present invention has been made with the aim of solving the above problems, and it is an object of the present invention to provide a lighting device which can be easily attached.

A lighting device according to the present invention is a lighting device having a light source unit attached to a main body, and is characterized by comprising: a driving unit that drives the light source unit; and a grip, wherein the driving unit and the grip are juxtaposed with the light source unit on the main body.

According to the present invention, the driving unit and the grip are provided in a state of being juxtaposed with the light source unit attached to the main body (e.g. a plate-form body frame). Thereby, the worker can install the lighting device only by attaching the main body to an installation location such as a ceiling surface while holding the grip. That is, it is unnecessary to perform attachment work a plurality of number of times such as attaching a lighting fixture housing and then, attaching the LED modules, etc. as in the conventional art, and the attachment of the lighting device is completed by performing attachment work once, so that the work process can be simplified. In addition, since the grip is provided, workability is improved.

The lighting device according to the present invention is characterized by comprising: a light permeable plate through which light from the light source unit passes; and a detachable cover that covers the driving unit and the grip, and is adjacent to the light permeable plate.

According to the present invention, the lighting device has: the light permeable plate through which light from the light source unit passes; and the detachable cover that covers the driving unit and the grip, and is adjacent to the light permeable plate. Since the cover for covering the driving unit and the grip is adjacent to the light permeable plate, the light from the light source unit is never intercepted. Moreover, when the lighting device is attached, it can be performed to detach the cover, attach the main body to an installation location such as a ceiling while holding the grip and then, attach the cover.

The lighting device according to the present invention is characterized in that the light source unit is provided two in number with the driving unit in between, partition members are opposite to each other on the main body, which divide the driving unit from the light source units, and the grip is provided so as to couple the partition members together.

According to the present invention, the two light source units are provided with the driving unit in between. The partition members are opposite to each other on the main body, which divide the driving unit from the light source units. The grip is provided in such a way as to couple the partition members together. Since the main body has, for example, a plate-form structure in which the two light source units are juxtaposed with the driving unit in between, by coupling the partition members together by the grip, a bend and the like of the main body can be suppressed, so that the stiffness of the lighting device can be enhanced.

The lighting device according to the present invention is characterized in that the two grips are provided so as to be separated at an appropriate distance from each other.

According to the present invention, the two grips are provided so as to be separated at an appropriate distance from each other. Thereby, even when the lighting device is large in size, the stiffness of the lighting device is further enhanced, and the main body can be attached to a ceiling or the like while the two grips are held with both hands, so that workability is further improved.

The lighting device according to the present invention is characterized in that the main body has an attachment member for attaching the main body to a given installation location.

According to the present invention, the main body is provided with the attachment member for attaching the main body to a given installation location. The attachment member may be an attachment hole formed on the main body or may be a metal piece such as a hook capable of being attached to an attachment metal piece previously fixed to a ceiling surface. Thereby, the main body can be installed on an installation location such as a ceiling.

According to the present invention, the work process can be simplified. In addition, workability is improved.

The above and further objects and features will more fully be apparent from the following detailed description with accompanying drawings.

### BRIEF DESCRIPTION OF THE SEVERAL VIEWS OF THE DRAWINGS

FIG. 1 is an external perspective view of a lighting device of an embodiment according to the present invention;

FIG. 2 is an exploded perspective view of the lighting device of the embodiment according to the present invention;

FIG. 3 is a plan view seen from below of the lighting device of the embodiment according to the present invention;

FIG. 4 is a plan view seen from below of the lighting device, with a center cover detached, of the embodiment according to the present invention;

FIG. 5 is a V-V line cross-sectional view of FIG. 3;

FIG. 6 is a plan view of a grip;

FIG. 7 is a front view of the grip; and

FIG. 8 is a side view of the grip.

### DETAILED DESCRIPTION

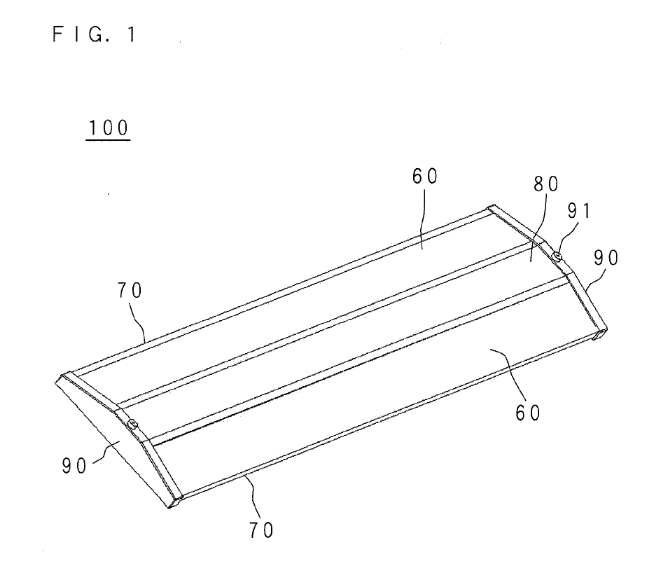

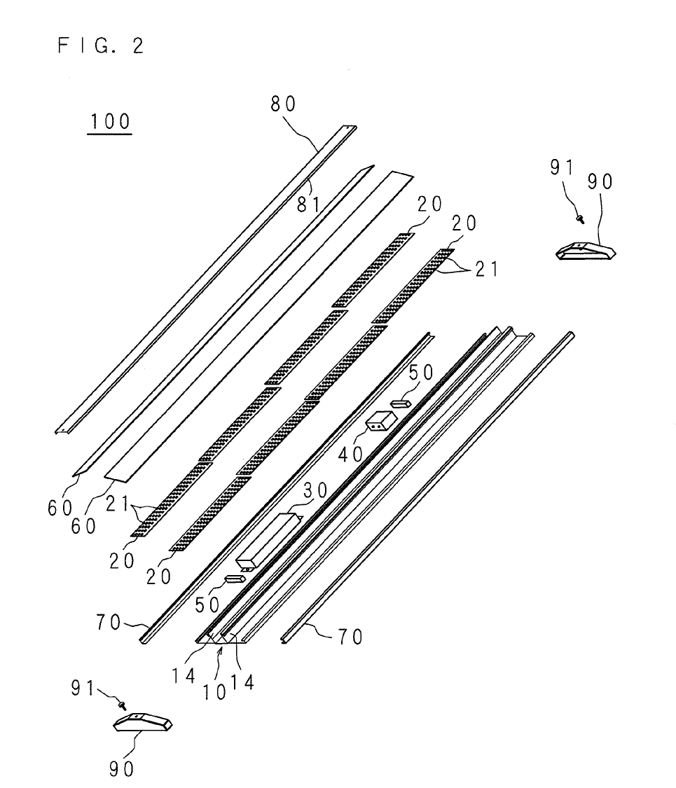

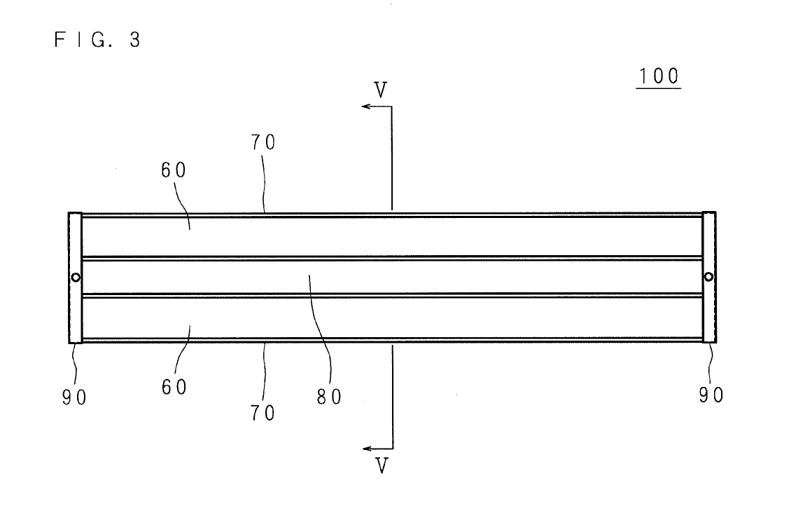

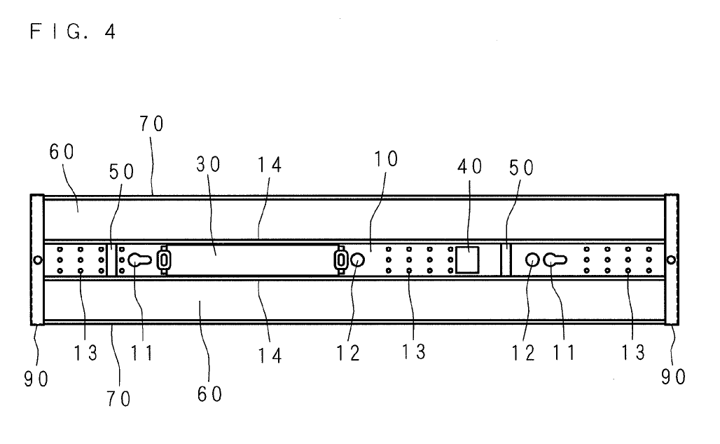

The following will describe in detail the present invention with reference to the drawings illustrating some embodiments thereof. FIG. 1 is an external perspective view of a lighting device 100 of the embodiment according to the present invention, FIG. 2 is an exploded perspective view of the lighting device 100 of the embodiment according to the present invention, FIG. 3 is a plan view seen from below of the lighting device 100 of the embodiment according to the present invention, and FIG. 4 is a plan view seen from below of the lighting device 100, with a center cover 80 detached, of the embodiment according to the present invention. The lighting device 100 includes: a plate-form body frame 10 as the lighting device main body; LED modules 20 as the light source units in which a plurality of LEDs 21 are mounted on a substrate; a power-supply unit 30 as the driving unit that supplies required electric power (may be a voltage or a current) to the LED modules 20; a connection terminal 40 that connects the power-supply wire from the commercial power source; grips 50 as grip members; light permeable panels 60 as the light permeable plates through which the light from the LED modules 20 passes; side plates 70 provided along the longitudinal direction of the body frame 10, and sandwiching the body frame 10 and the light permeable panels 60; the center cover 80 as the cover that covers the power-supply unit 30, the grips 50 and the connection terminal 40; side covers 90; and the like.

As shown in FIG. 2, partition plates 14, 14 as two partition members are opposite to each other on the body frame 10 along the longitudinal direction of the rectangular body frame 10. The power-supply unit 30, the connection terminal 40, the grips 50, etc., are juxtaposed with the LED modules 20 in a compartment defined between the partition plates 14. Further, the LED modules 20 are mounted in the compartments defined between each of the partition plates 14 and each of the long side edges of the body frame 10. Namely, two groups of the LED modules 20 are juxtaposed on the body frame 10 so that the power-supply unit 30, the connection terminal 40, and the like are provided between the two groups of the LED modules 20.

Moreover, as shown in FIG. 2, the center cover 80 is fixed to the side covers 90 by screws 91. Metal pieces having screw holes may be provided upright on the short side edges of the body frame 10 so that the center cover 80 is fixed to the metal pieces. In any case, when the lighting device 100 (body frame 10) is attached to a ceiling or the like, it can be performed to detach the center cover 80, attach the lighting device 100 to the ceiling or the like while holding the grips 50 and then, attach the center cover 80.

As shown in FIG. 2, the center cover 80 is provided with curved portions 81 into which long side edges thereof are bent in an L shape. It may be performed to provide concave portions so as to be separated at an appropriate distance on edges of the curved portions 81 and provide, in corresponding positions of the partition plates 14, members such as protrusions for engaging the concave portions therewith. Thereby, the center cover 80 can be prevented from becoming depressed toward the body frame 10. It may be performed to provide convex portions on the edges of the curved portions 81 instead of the concave portions, provide concave portions in corresponding positions of the partition plates 14 and engage them with each other. Any structure may be adopted as long as the center cover 80 can be prevented from being bent.

Moreover, as shown in FIG. 3, the two light permeable panels 60 are disposed with the center cover 80 in between. The light permeable panels 60 are, as shown in FIGS. 1 and 2, inclined in such a way that the separation distance between the body frame 10 and the light permeable panels 60 (the height of the light permeable panels 60) decreases along a direction toward the long side edges of the body frame 10. The separation distance between the body frame 10 and the light permeable panels 60 (the height of the light permeable panels 60) is made larger in parts other than the edges such as a central part and parts near the central part of the body frame 10 than in parts near the edges. Thereby, a wider area (e.g. a direction orthogonal to the longitudinal direction of the body frame 10) can be lighted with the light from the LED modules 20, so that the light distribution to the ceiling surface can be increased.

That is, the light permeable panels 60 are inclined in such a way that the separation distance decreases toward the edges of the body frame 10. Thereby, for example, when the lighting device 100 is installed on a ceiling surface, the light from the light permeable panels 60 (LED modules 20) is not only radiated substantially vertically to the ceiling surface but also radiated to the peripheral sides of the lighting device 100. Consequently, light can also be radiated to the ceiling surface around the lighting device 100, so that the light distribution characteristic can be made wider than before.

Moreover, by adopting a structure (not a two-tier structure) in which the LED modules 20 and the power-supply unit 30 are juxtaposed on the body frame 10, it is unnecessary to adopt a two-tier structure like that of the conventional device, the height of the light permeable panels 60 from the ceiling surface can be reduced, and the light distribution to the ceiling surface can be increased, so that the light distribution characteristic can be further widened.

Moreover, the power-supply unit 30 is disposed substantially in a central part of the body frame 10, and the LED modules 20 and the light permeable panels 60 are respectively provided two in number with the power-supply unit 30 in between. Thereby, when the lighting device 100 is installed on a ceiling surface, the light distribution to the ceiling surface on both sides of the lighting device 100 can be increased, so that the light distribution characteristics can be further widened.

While in the above-described example, the LED modules 20 and the light permeable panels 60 are provided two in number with the power-supply unit 30 in between, the present invention is not limited thereto; for example, the LED modules 20 and the light permeable panels 60 may be disposed on the entire periphery of the power-supply unit 30. In any case, by disposing the power-supply unit 30 in a central part of the body frame 10, the inclined light permeable panels 60 can be made close to the ceiling surface (the height can be made small) in the vicinity of the edges of the body frame 10, so that the light distribution characteristic can be further widened.

Moreover, as shown in FIG. 4, in the body frame 10, attachment holes 11 as attachment members for attaching the body frame 10 to an installation location such as a ceiling are formed. The attachment holes 11 are merely an example and the present invention is not limited thereto; members such as hooks or notches may be used as long as the structure is such that the body frame 10 can be attached to an installation location. Thereby, the body frame 10 can be installed on an installation location such as a ceiling. Moreover, as shown in FIG. 4, the body frame 10 may be provided with a plurality of screw holes 13. This enables direct attachment to a ceiling or the like. Moreover, in the body frame 10, distribution holes 12, 12 for distributing power-supply wires and the like to appropriate places are formed.

Between the partition plates 14, 14 provided parallel on the body frame 10, the grips 50 are provided so as to be separated at an appropriate distance (e.g. approximately 80 cm that can be sufficiently reached by a person with arms spread). Moreover, the fixing positions of the grips 50 may be determined, for example as shown in FIG. 4, so that the power-supply unit 30 is therebetween in consideration of the balance (center of gravity) between the power-supply unit 30 and the body frame 10 which are comparatively weighty.

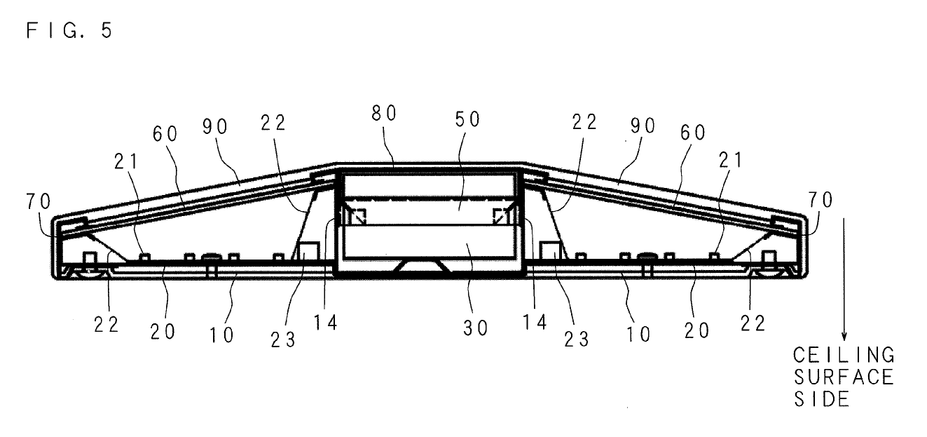

FIG. 5 is a V-V line cross-sectional view of FIG. 3. As shown in FIG. 5, the power-supply unit 30 is provided between the LED modules 20 on the body frame 10. For this reason, compared with the conventional case where the light source unit and the power-supply unit are formed into a two-tier structure, the height (thickness) of the lighting device 100 can be reduced, so that a low-profile lighting device can be realized.

Moreover, the substrates of the LED modules 20 are respectively mounted with a connector 23 for connecting the wiring from the power-supply unit 30. Moreover, to efficiently radiate the light from the LED modules 20, reflecting sheets 22 bent substantially in a U shape when viewed cross-sectionally are provided. The reflecting sheets 22 are disposed so that both edges thereof are situated on both edges of the light permeable panels 60. Thereby, the light from the LED modules 20 can be prevented from leaking to the inside of the lighting device 100, so that light extraction efficiency can be improved.

As described above, by adopting the structure in which the LED modules 20 and the power-supply unit 30 are juxtaposed on the plate-form body frame 10 and further adopting the structure in which the LED modules 20, the power-supply unit 30 and the grips 50 are juxtaposed on the body frame 10, the worker can install the lighting device 100 only by attaching the body frame 10 to an installation location such as a ceiling surface while holding the grips 50. That is, it is unnecessary to perform attachment work a plurality of number of times such as attaching a lighting fixture housing and then, attaching the LED modules, etc. as in the conventional art, and the attachment of a lighting device is completed by performing attachment work once, so that the work process can be simplified. In addition, since the grips 50 are provided, workability is improved.

Moreover, since the detachably attachable center cover 80 is disposed adjacent to the light permeable panels 60 through which the light from the LED modules 20 passes, the light from the LED modules 20 is never intercepted. Moreover, when the lighting device 100 is attached to a ceiling or the like, it can be performed to detach the center cover 80, attach the body frame 10 to the installation location such as a ceiling while holding the grips 50 and then, attach the center cover 80, so that workability is improved.

Moreover, the grips 50 are provided in such a way as to couple the partition plates 14 together. Since the body frame 10 has a plate-form structure, by coupling the separated partition plates 14 together by the grips 50, a bend and the like of the body frame 10 can be suppressed, so that the stiffness of the lighting device 100 can be enhanced.

Moreover, the center cover 80 and the light permeable panels 60 are rectangular when viewed two-dimensionally, the partition plates 14 are provided along the borders between the center cover 80 and the light permeable panels 60, and the two grips 50 are provided so as to be separated at an appropriate distance from each other. Thereby, even when the lighting device 100 is large in size, the stiffness of the lighting device 100 is further enhanced, and the body frame 10 can be attached to a ceiling or the like while the two grips 50 are held with both hands, so that workability is further improved.

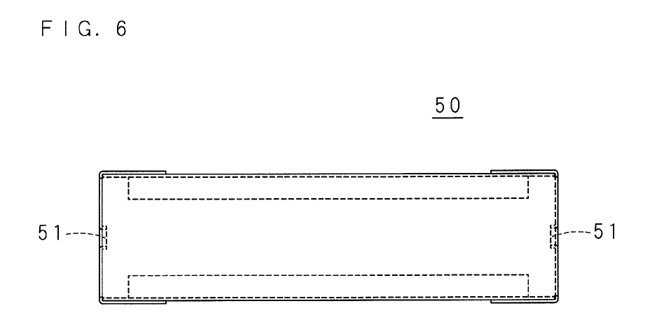

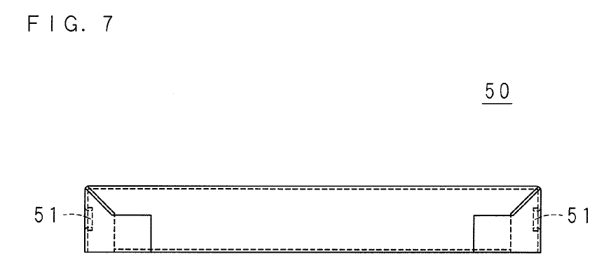

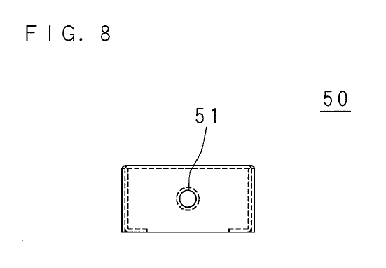

Next, the grips 50 will be described. FIG. 6 is a plan view of the grips 50, FIG. 7 is a front view of the grips 50, and FIG. 8 is a side view of the grips 50. As shown in FIGS. 6 to 8, the grips 50 are formed in a hollow rectangular parallelepiped shape into which a flat plate is bent, and can be fixed to the partition plates 14 by making the side surfaces thereof abut on the partition plates 14 and inserting screws into screw holes 51. The shape of the grips 50 is not limited to the example of the figures; it may be a different shape such as a cylindrical shape or a triangular prism shape. Any shape may be adopted as long as the structure is such that the partition plates 14 can be coupled together. Moreover, the method of attachment of the grips 50 to the partition plates 14 is not limited to screws; a different fixing method such as welding may be used.

While the grips 50 are fixed between the partition plates 14 in the above-described example, the present invention is not limited thereto; for example, grips may be used that are formed in such a way that plate members or rod-like members of a dimension substantially the same as that of the short side of the body frame 10 are fixed along the direction of the short side of the body frame 10 and between the partition plates 14, the plate members or the rod-like members are separated from the body frame 10 so that a space enough for putting a hand therein is formed.

As described above, according to the present invention, the attachment of a lighting device is completed by performing attachment work once, so that the work process can be simplified. Moreover, since the grips are provided, workability is improved to reduce work time, and the safety at the time of the work can be improved. There are a considerable number of demands for lighting devices in line with demands for new constructions and renovations, and the simplification of the installation work of lighting devices leads to a reduction in the cost required for the work. Moreover, even in situations where the process management of a renovation or the like is harsh because of a reduced work time, the demands can be satisfied.

According to the above-described embodiment, the light distribution characteristic can be widened; for example, when a lighting device is installed on a ceiling surface, the ceiling surface around the lighting device can be lighted, so that the entire room can be lighted. In particular, since lighting devices used in stores, convenience stores and the like are required to illuminate the indoor space, the lighting device according to the present invention in which the light distribution characteristic of the light source is widened so that the ceiling surface is also lighted with the light from the light source is usable for various purposes.

While in the above-described embodiment, the lighting device is a so-called straight-type lighting device that is rectangular, the shape of the lighting device is not limited to the straight type; it may be a so-called square type or circular type. For example, in the case of a circular lighting device, the body frame is circular, the power-supply unit and a grip (e.g. one grip) are disposed in a central part, and LED modules are concentrically disposed therearound. Moreover, the shape of the light permeable panels 60 is not limited to the rectangle, either; a different shape such as a square, a circle or a concentric circle may be adopted in accordance with the shape of the body frame.

While the center cover 80 is screwed in the above-described embodiment, the present invention is not limited thereto; it may be sandwiched between the side covers 90. Moreover, the cover is not limited to a plate-form member such as the center cover 80 but members of various structures such as a curved member that is curved in cross section or a member having a slit may be used as long as it covers the power-supply unit 30, the grips 50 and the like.

While the partition plate 14 is illustrated as the partition member in the above-described embodiment, the partition member is not limited to a plate-form member, any member may be used as long as it has a structure capable of partitioning the power-supply unit 30, the grips 50 and the like, and the LED modules 20.

As this description may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1.-5. (canceled)

6. A lighting device comprising:
a light source unit attached to a main body;
a driving unit that drives the light source unit; and a grip,
wherein the driving unit and the grip are juxtaposed with the light source unit on the main body.

7. The lighting device according to claim 6, comprises:
a light permeable plate through which light from the light source unit passes; and
a detachable cover that covers the driving unit and the grip, and is adjacent to the light permeable plate.

8. The lighting device according to claim 6, wherein
the light source unit is provided two in number with the driving unit in between,
partition members are opposite to each other on the main body, which divide the driving unit from the light source units, and
the grip is provided so as to couple the partition members together.

9. The lighting device according to claim 7, wherein
the light source unit is provided two in number with the driving unit in between,
partition members are opposite to each other on the main body, which divide the driving unit from the light source units, and
the grip is provided so as to couple the partition members together.

10. The lighting device according to claim 6,
wherein the grip is provided two in number so as to be separated from each other.

11. The lighting device according to claim 7,
wherein the grip is provided two in number so as to be separated from each other.

12. The lighting device according to claim 8,
wherein the grip is provided two in number so as to be separated from each other.

13. The lighting device according to claim 6,
wherein the main body has an attachment member for attaching the main body to a given installation location.

14. The lighting device according to claim 7,
wherein the main body has an attachment member for attaching the main body to a given installation location.

15. The lighting device according to claim 8,
wherein the main body has an attachment member for attaching the main body to a given installation location.

16. The lighting device according to claim 10,
wherein the main body has an attachment member for attaching the main body to a given installation location.
